(19) United States
(12) Patent Application Publication
(10) Pub. No.: US 2015/0009714 A1
(43) Pub. Date: Jan. 8, 2015

(54) LIGHT SOURCE SUBSTRATE AND LIGHT SOURCE MODULE

(71) Applicant: SHARP KABUSHIKI KAISHA, Osaka-shi, Osaka (JP)

(72) Inventors: Masanobu Okano, Osaka-shi (JP); Ken Sumitani, Osaka-shi (JP); Shingo Kamitani, Osaka-shi (JP)

(73) Assignee: SHARP KABUSHIKI KAISHA, Osaka-shi, Osaka (JP)

(21) Appl. No.: 14/372,361

(22) PCT Filed: Jan. 22, 2013
(86) PCT No.: PCT/JP2013/051115

§ 371 Date: Jul. 15, 2014

(30) Foreign Application Priority Data
Feb. 17, 2012 (JP) 2012-033070

(51) Int. Cl. F21V 8/00

(52) U.S. Cl. CPC G02B 6/0073
USPC 362/631

(57) ABSTRACT

To provide a light source substrate in an edge-light-type light source module, with which a defect generated by contacting of a sealing member of the light source substrate coming into contact with a lightguide plate can be prevented and reliability and safety can be improved. A light source substrate has a plurality of light-emitting elements (LED elements 15) COB-mounted on a base member 11, and is used in an edge-light-type light source module. Light source substrates 30 to 90 are configured with a first protrusion that forms a dam 17 for housing the sealing member, and a second protrusion 18 that is formed higher than the first protrusion and prevents the sealing member from coming into contact with other members.

### TECHNICAL FIELD

The present invention relates to a light source substrate for COB-mounting light-emitting elements, as well as a light source module configured using the light source substrate.

### BACKGROUND ART

Light source substrates having mounted light-emitting diodes (LEDs), or light source modules using these light source substrates are becoming more widely used of late. Although cold cathode fluorescent lamps (CCFLs) were the mainstream in the past as light sources of liquid-crystal backlights, a switch to light source modules using LED elements is progressing rapidly. By this switch, mercury, which has a high environmental load, is no longer used, power consumption is reduced, and the service life of backlights can be prolonged.

A LED light source module used for such use is usually realized by using a light source substrate on which LED elements are mounted on a substrate by some method, and chip on board (COB) can be used as one method for mounting the LED elements (see, for example, patent document 1).

In a LED light source substrate obtained using COB, the method for mounting on a printed substrate a LED package housing LED elements in the package differs in that the LED element is directly mounted on the substrate. Therefore, an improvement in heat radiation by not using soldering can be expected, and defects of LEDs in which characteristics or service life generally degrade due to heat can be corrected.

In a LED light source substrate having LED elements mounted with COB, the LED elements or bonding wires are sealed by potting using a resin, or the like. By this sealing, the LED elements or bonding wires can be protected from external impact, moisture, foreign matter, and the like. Light emission in white or other desired color furthermore can easily be obtained by using blue LEDs or ultraviolet diodes for the LED elements and mixing fluorescent bodies in the potting material.

Because white or near-white light emission is required for illumination or liquid-crystal backlight modules, a method using blue LED elements and mixing yellow fluorescent bodies or a plurality of kinds of fluorescent bodies including red and green in the potting material is effective. Epoxy resin or silicone resin is mainly used when resin is used as the material of the potting material. Silicone resin in particular is pliable, and therefore is an effective choice for alleviating stress received by the LED elements, bonding wires, connected portions, and the like.

In the sealing process, a dam is formed using a dam material on the periphery of the sealed portion, and the potting material is injected and cured inside the dam. Injection is commonly performed using a dispenser, and curing by a process of heat-curing in a high-temperature tank. In these injection and curing processes, a dam surrounding the sealed portion is necessary in order to avoid an outflow of potting material. The dam can be integrally molded simultaneously with the substrate when manufacturing the substrate of the light source substrate by injection molding or other means having a high degree of freedom of shape. This method is useful for reduction of assembly cost or throughput of production by the fact that there is no need to separately form the dam. In a LED light source substrate by COB, the aforementioned integral molding of the dam with the substrate is possible because the resin can be injection-molded as insulating material on the lead frame as a wiring layer when the substrate is formed.

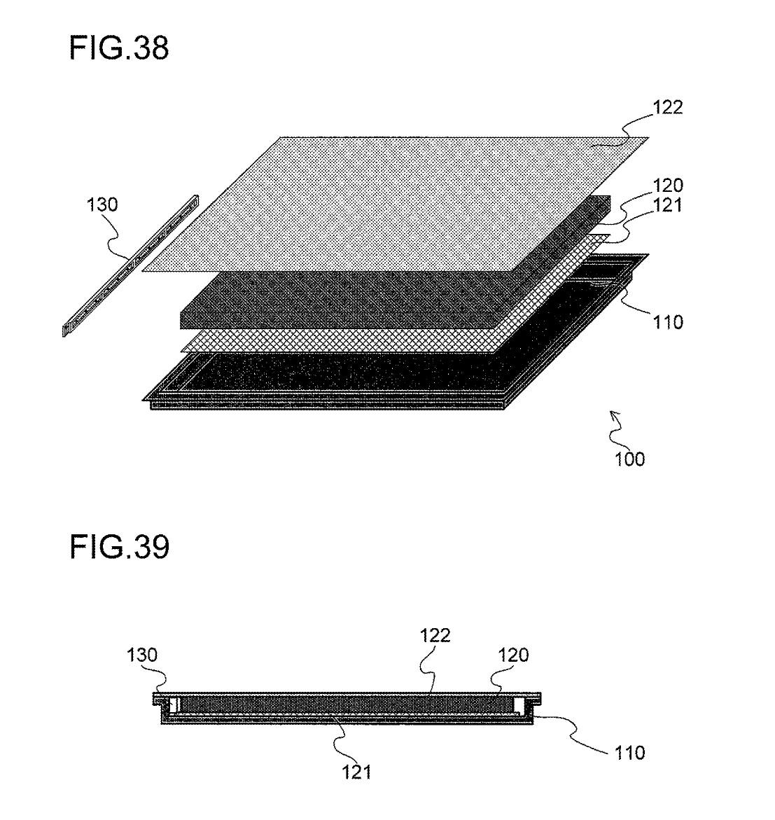

A LED light source substrate using LED elements and a LED light source module using the LED light source substrate are next described using FIGS. 38 to 43.

FIG. 38 is an exploded perspective view illustrating one example of the configuration of the main parts of a LED light source module 100 according to the prior art, and FIG. 39 is a sectional view in the assembled state. The LED light source module 100 of the prior configuration comprises a case 110, a lightguide plate 120, a reflective sheet 121, a diffusion sheet 122, and a LED light source substrate 130.

The light generated from the LED light source substrate 130 is introduced on an incident surface being one side surface of the lightguide plate 120. The light introduced from the incident surface is mixed and made uniform inside the lightguide plate, and is emitted as planar light from a top surface, which is an illuminating surface. The reflective sheet 121 has a function of returning to the lightguide plate light having leaked to the side opposite the illuminating surface from the lightguide plate, and contributes to improvement of light utilization efficiency. The diffusion sheet 122 makes uniform the light emitted from the lightguide plate 120, and has an effect of reducing uneven brightness. The case 110 houses and secures these members.

The LED light source module 100, by being configured as above, functions as a planar illumination module utilizing light emission from the LED elements.

A light source in which light illuminating from an edge of a screen is changed to planar illumination using some kind of lightguide means, as in the abovementioned LED light source module 100, is called “edge-type,” which is advantageous for making the light source module thinner than a perpendicular-type, in which the light source is placed in a planar form directly beneath the illuminating surface. Accordingly, such edge-type LED light source modules 100 have become common in light sources of liquid crystal modules in which there is a strong demand for making the product thin (see, for example, patent documents 1 to 5).

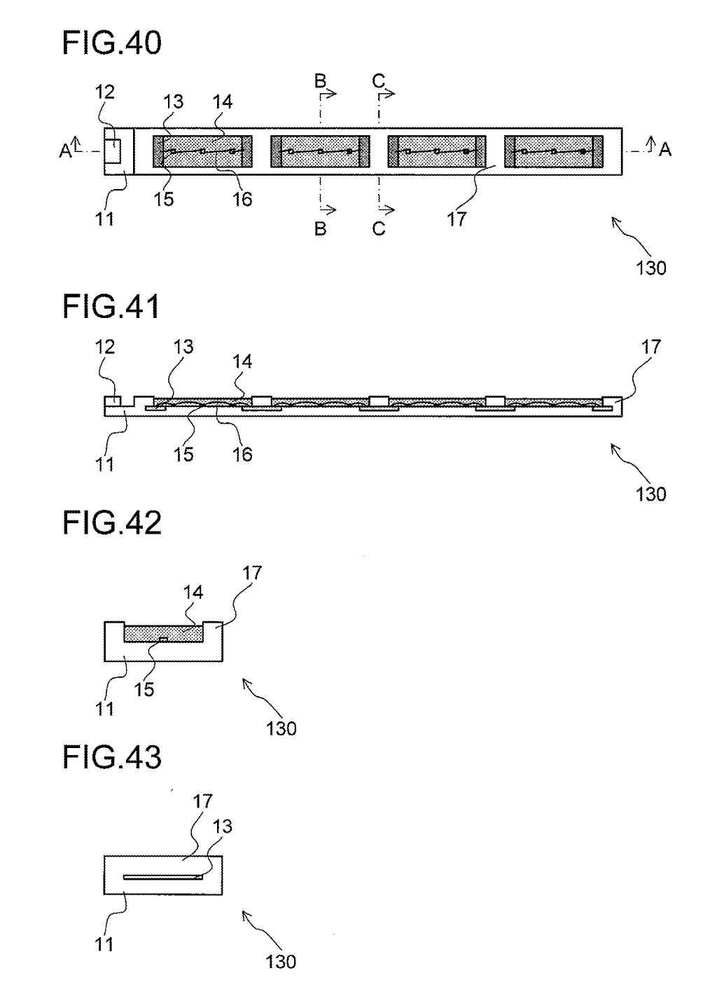

The LED light source substrate 130 is next further described below using FIGS. 40 to 43. FIG. 40 is a plan view of a LED light source substrate 130 according to the prior art. FIG. 41 is a sectional view along arrow A-A of the LED light source substrate 130 illustrated in FIG. 40. FIG. 42 is a sectional view along arrow B-B of the LED light source substrate 130 illustrated in FIG. 40, and FIG. 43 is a sectional view along arrow C-C of the LED light source substrate 130 illustrated in FIG. 40.

The LED light source substrate 130 is one example of a LED light source substrate in which LED elements 15 are directly mounted on a substrate using COB. That is, the LED elements 15 are directly mounted on a base member 11. Or, a configuration is also possible in which a mounted layer is separately prepared and the LED elements 15 are mounted on a surface thereof. In either case, in COB the LED elements 15 are directly mounted on the substrate (base member 11) rather than being mounted indirectly using a package.

In the LED light source substrate 130, a wiring layer 13 and the LED elements 15 are electrically connected by bonding wires 16. Also, although not specifically illustrated, the wiring layer 13 is electrically connected with an electrode terminal having connectors 12. By this configuration, the emission of light from the LED elements 15 can be controlled by electrically controlling a harness (not illustrated) connected to the connectors 12.

Because the LED elements 15, bonding wires 16, and places of connection thereof are easily damaged by impact, the LED elements 15 and the bonding wires 16, including the connected portions, are sealed by a sealing material 14 as a countermeasure. By this configuration, the LED elements 15 and the bonding wires 16 can withstand an impact to a certain extent from outside, and additionally are protected from moisture, foreign matter, and the like. However, an impact on the sealing material 14 is transmitted indirectly to the LED elements 15, bonding wires 16, and places of connection thereof. Accordingly, an impact at or above a certain extent applied to the sealing material 14 may break the LED elements 15 or the bonding wires 16, cause peeling of the connections, or other adverse events.

A dam 17 surrounding the sealing material 14 is formed on the base member 11, and is made higher than the places where the LED elements 15 are mounted. By this configuration, the sealing material 14 can be prevented from flowing out during injection of the sealing material 14, and production characteristics are improved.

### LIST OF CITATIONS

### Patent Literature

Patent Document 1: Japanese Laid-open Patent Application No. 2008-277561

Patent Document 2: Japanese Laid-open Patent Application No. 2011-129508

Patent Document 3: Japanese Laid-open Patent Application No. 2011-113865

Patent Document 4: Japanese Laid-open Patent Application No. 2010-276628

Patent Document 5: Japanese Laid-open Patent Application No. 2011-216270

### SUMMARY OF INVENTION

### Technical Problem

As described above, the LED elements and the bonding wires in a light source substrate having the LED elements mounted with COB are sealed and are protected from external stress, moisture, foreign matter, and the like. However, this protection is generally insufficient. Because the protection achieved by this sealing material only avoids direct contact, stress applied to the sealing material can be alleviated to some extent, but cannot be completely blocked. Accordingly, breaking of LED elements, breaking of bonding wires, peeling of bonding wires, and other defects may still occur due to stress.

In order to prevent these defects, a mechanism by which countermeasures are fully taken is required so that, inter alia, other parts do not contact the sealing material in a state in the assembled state of the light source module. Care in the assembly operation is furthermore required so that accidental contact is avoided during assembly of the light source module. The place to be most careful about contact with the sealing material in these situations, in terms of the structure of the light source module, is the light source substrate and the lightguide plate placed in parallel and immediately nearby.

For example, in patent documents 2 and 3, contact between the light source portion and the lightguide plate is prevented by adding a special configuration to the lightguide plate. According to the configuration in patent document 4, by preparing a special configuration separately from the lightguide plate or light source unit, contact between the light source portion and the lightguide plate can be prevented because a positional relationship between these can be fixed. However, with these methods, because special parts or contrivances are prepared for the lightguide plate or mechanism, an increase of the production process or production cost for parts or modules cannot be avoided.

A member higher than the light source portion also can be provided on the light source substrate as described in patent document 5. In a light source substrate having LED elements mounted with COB, as described with the example of the LED light source substrate 130, a dam higher than the light source portion can be provided in order to form the sealing material for sealing the light source portion using resin.

The fact that contacting of the sealing resin with the lightguide plate can also be prevented by making this dam higher is the same as in patent document 5. However, an optical effect cannot be avoided when the dam is made higher. Specifically, light input to a portion where a shadow of the dam appears is reduced viewed from the light-emitting element, and this becomes a cause of uneven brightness, and is unfavorable. Although the influence on the uneven brightness is comparatively small on a side near an end of the light source substrate, when considering the possibility that warping or other deformation may occur due to impact on the light source substrate or case, making only both ends higher is insufficient, and further making some number of places higher is more preferable, and the optical influence of such configuration becomes a problem.

The present invention was created in order to solve problems such as the abovementioned, a first object thereof being to prevent contact between the lightguide plate and the sealing resin to prevent the generation of defects even when the lightguide plate used in the light source module is in contact with the light source substrate. A further object is to improve characteristics of the light source substrate by using the design for achieving the first object.

That is, an object of the present invention is to provide a light source substrate, in an edge-light-type light source module, with which a defect generated by contacting of the scaling member of the light source substrate with the lightguide plate can be prevented and reliability and safety can be improved.

### Solution to Problem

The present invention for achieving the abovementioned object is a light source substrate used in an edge-light-type light source module, comprising: a base member comprising a molding, a wiring layer formed on the base member, a plurality of light-emitting elements COB-mounted on the wiring layer, a connecting member for connecting the light-emitting elements and the wiring layer, and a sealing member for sealing the connecting member and the light-emitting element. The light source substrate is provided with a first protrusion that forms a dam for housing the sealing member, and a second protrusion that is formed higher than the first protrusion and prevents the sealing member from coming into contact with other members.

By this configuration, contact between the sealing member and a member provided on the light source module, for example, the lightguide plate can be avoided by the second protrusion. When the lightguide plate and the sealing member come into contact, the light-emitting elements or the connecting member are subject to damage, and this becomes a cause of damage of the light source substrate. Therefore, reliability and safety of the light source substrate can be increased by adopting a configuration such that such contact can be avoided.

In the light source substrate of the abovementioned configuration, preferably the first protrusion and the second protrusion are integrally molded. By this configuration, there is no need to add a separate process for forming the second protrusion, and therefore the manufacturing cost can be reduced.

In the light source substrate of the abovementioned configuration, preferably the second protrusion is provided on a surface of the first protrusion. By this configuration, the addition of shape necessary for provision of the second protrusion can be kept to a minimum, and manufacturing becomes easier.

In the light source substrate of the abovementioned configuration, preferably the second protrusion has a shape of a part of a sphere or is a pyramid. By this configuration, the area of the portion proximal to the lightguide plate of the light source module can be minimized, and therefore the influence of the second protrusion on optical characteristics of the light source module can be reduced.

In the light source substrate of the abovementioned configuration, preferably the second protrusion is a protrusion that continues along a short-side direction of the substrate main body. By this configuration, contacting of the sealing material with the lightguide plate can be more effectively prevented than by the aforementioned configuration.

In the light source substrate of the abovementioned configuration, preferably the second protrusion is a long-strip-form protrusion that is arranged along a long-side direction of the substrate main body. By this configuration, the lightguide plate can be stably supported via the long-strip-form protrusion, and contacting of the sealing material with the lightguide plate can be more effectively prevented.

In the light source substrate of the abovementioned configuration, preferably a plurality of the second protrusions is provided along a long-side direction of the substrate main body. By this configuration, contacting of the sealing material with the lightguide plate can be more effectively avoided compared with the case when a single protrusion is included.

In the light source substrate of the abovementioned configuration, preferably there is a third protrusion that is higher than the second protrusion. By this configuration, contact with the lightguide plate can be avoided by the second protrusion, while the lightguide plate can be sandwiched and fixed in position by the third protrusion. Leakage of light from between the light source substrate and the lightguide plate on the long side furthermore can be prevented, and light utilization efficiency can be improved.

In the light source substrate of the abovementioned configuration, preferably the third protrusion is integrally molded with the base member. By this configuration, there is no need to add a separate process for forming the third protrusion, and therefore the manufacturing cost can be reduced.

In the light source substrate of the abovementioned configuration, preferably the third protrusion is provided on a surface of the second protrusion. By this configuration, the addition of shape necessary for provision of the third protrusion can be kept to a minimum, and manufacturing becomes easier.

In the light source substrate of the abovementioned configuration, preferably the second protrusion has a flat part on an upper surface thereof. By this configuration, the other members can be stably mounted on the flat part; for example, the lightguide plate can be supported over a wide area.

In the light source substrate of the abovementioned configuration, preferably there is a fourth protrusion that is higher than the third protrusion. By this configuration, contact with the lightguide plate can be avoided by the second protrusion, and the lightguide plate can be sandwiched and fixed in position by either the third protrusion or the fourth protrusion. Leakage of light from between the light source substrate and the lightguide plate on the long side furthermore can be prevented, and light utilization efficiency can be improved. Lightguide plates having different thicknesses also can be accommodated by separating use of the third protrusion and the fourth protrusion.

In the light source substrate of the abovementioned configuration, preferably the fourth protrusion is integrally molded with the base member. By this configuration, there is no need to add a separate process for forming the fourth protrusion, and therefore the manufacturing cost can be reduced.

In the light source substrate of the abovementioned configuration, preferably the fourth protrusion is provided on a surface of the third protrusion. By this configuration, the addition of shape necessary for provision of the fourth protrusion can be kept to a minimum, and manufacturing becomes easier.

In the light source substrate of the abovementioned configuration, preferably the second, third, and fourth protrusion are step-form, long-strip-form protrusions that are arranged along a long-side direction of the substrate main body. By this configuration, lightguide plates having different thicknesses can be more easily accommodated by separating use of the plurality of protrusions.

In the light source substrate of the abovementioned configuration, preferably the second and third protrusions have a flat part on a surface thereof. By this configuration, the other members can be stably mounted on the flat part; for example, the lightguide plate can be supported over a wide area.

The present invention also is a light source substrate used in an edge-light-type light source module, comprising: a base member comprising a molding, a wiring layer formed on the base member, a plurality of light-emitting elements COB-mounted on the wiring layer, a connecting member for connecting the light-emitting elements and the wiring layer, a sealing member for sealing the connecting member and the light-emitting element, and a protrusion forming a dam for housing the sealing member. The protrusion includes a first protrusion of sufficient height for housing the sealing member, a low portion that is formed higher than the first protrusion and is formed along a short side of the substrate main body, and a high portion that is formed higher than the first protrusion and is formed along a long side of the substrate main body.

By this configuration, contacting of the lightguide plate provided on the light source module with the sealing member can be avoided by the high portion of the protrusion. The influence of a portion of the protrusions having an influence on optical characteristics also can be alleviated by making that portion lower in height.

In the light source substrate of the abovementioned configuration, preferably there is a projecting part that is higher than the low portion and is lower than the high portion. By this configuration, leakage of light can be prevented by the high portion, and contacting of the sealing material with the lightguide plate can be prevented by the projecting part.

In the light source substrate of the abovementioned configuration, preferably the projecting part is provided on the low portion. By this configuration, the addition of shape necessary for provision of the projecting part can be kept to a minimum, and manufacturing becomes easier.

In the light source substrate of the abovementioned configuration, preferably the base member contains a white resin. By this configuration, the light emitted from the plurality of light-emitting elements can be efficiently introduced to the lightguide plate.

The present invention also is a light source module having the light source substrate of the above configuration and a lightguide plate. By this configuration, a light source module can be configured, having the effects described with the configuration of the light source substrate. That is, by using a light source substrate having high reliability and safety, a light source module can be obtained, having high reliability and safety and having impact resistance such that defects including breaking of LED elements, breaking of bonding wires, and peeling of bonding wires do not occur even when being subjected to an impact force, or other external force.

In the light source module, preferably the abovementioned lightguide plate is placed and fixed sandwiching any of the abovementioned third protrusion, the abovementioned fourth protrusion, and the abovementioned high portion. By this configuration, by providing a plurality of protrusions having different heights on the substrate main body, the plurality of protrusions can be used separately, and lightguide plates having different thickness can be easily accommodated. A portion having an influence on optical characteristics can be lowered, a portion preventing leakage of light can be raised, and light utilization efficiency can be improved.

### Advantageous Effects of the Invention

According to the present invention, by providing a second protrusion that is higher than a first protrusion that forms a dam in a light source substrate used in an edge-type light source module, contact between the sealing member for sealing the light-emitting elements mounted with COB and the lightguide plate provided in the light source module can be avoided, damage to the light-emitting elements or connecting member can be prevented, and degradation or breaking of the light source substrate can be prevented. Reliability and safety of the light source substrate therefore can be increased. A light source module having impact resistance and having high reliability and safety furthermore can be obtained by using such light source substrate.

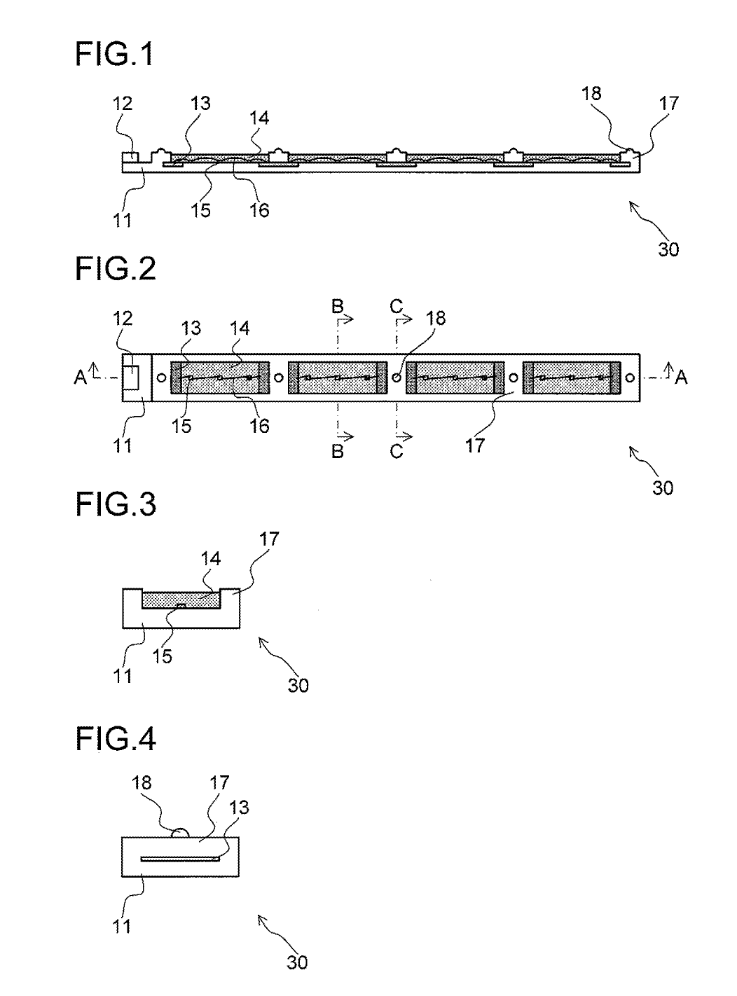

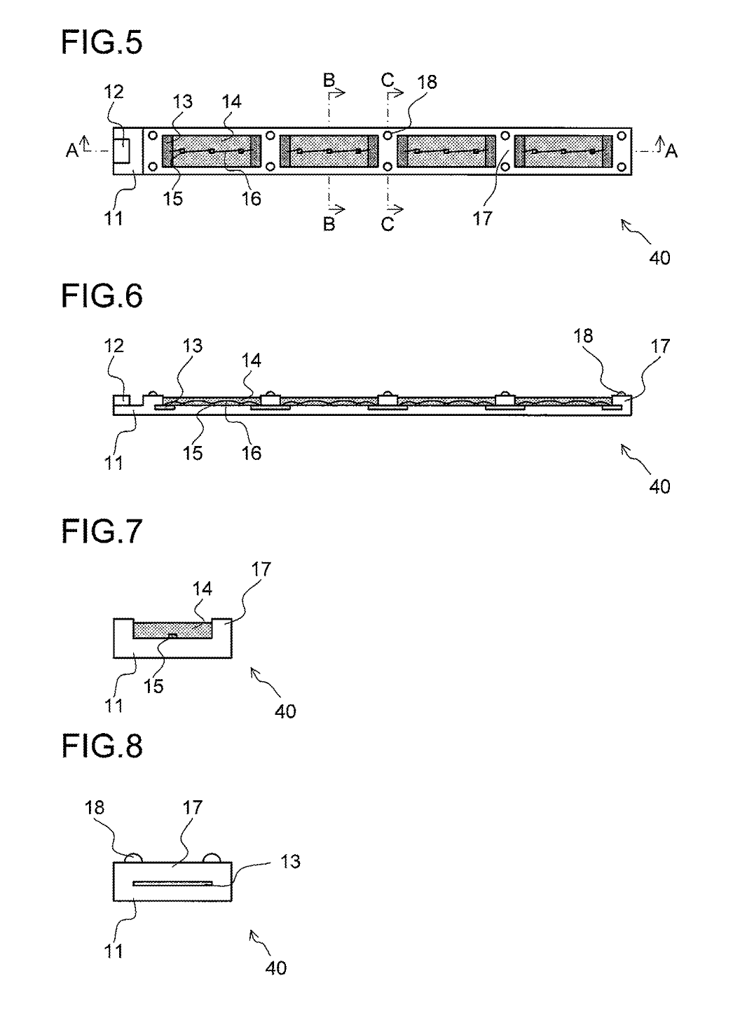

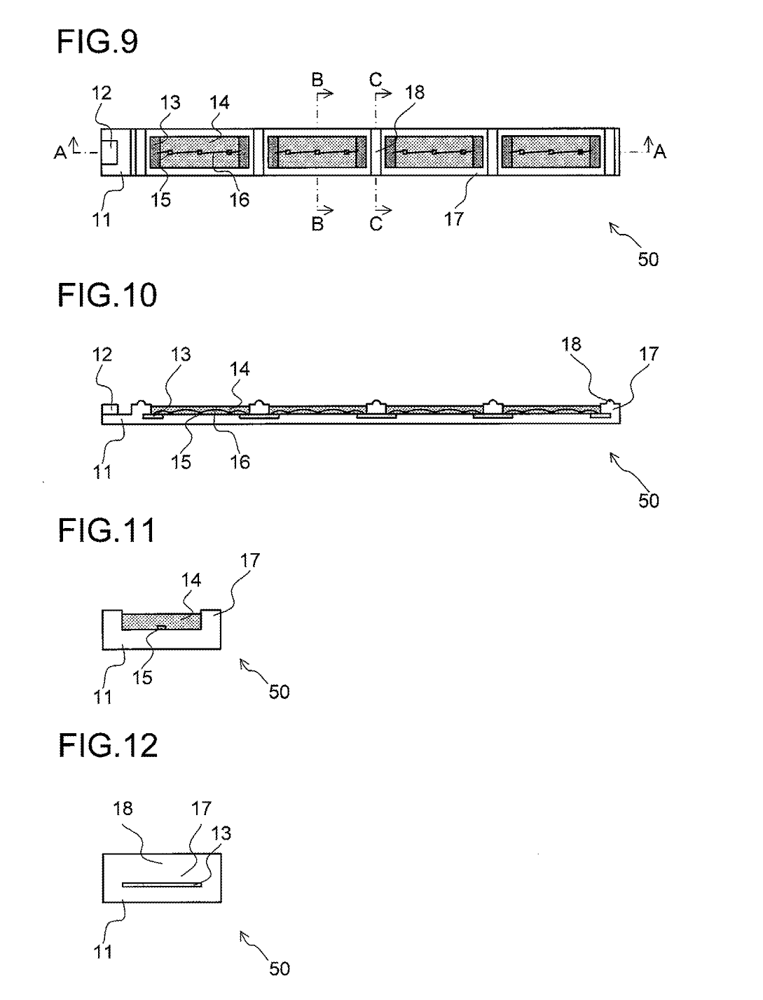

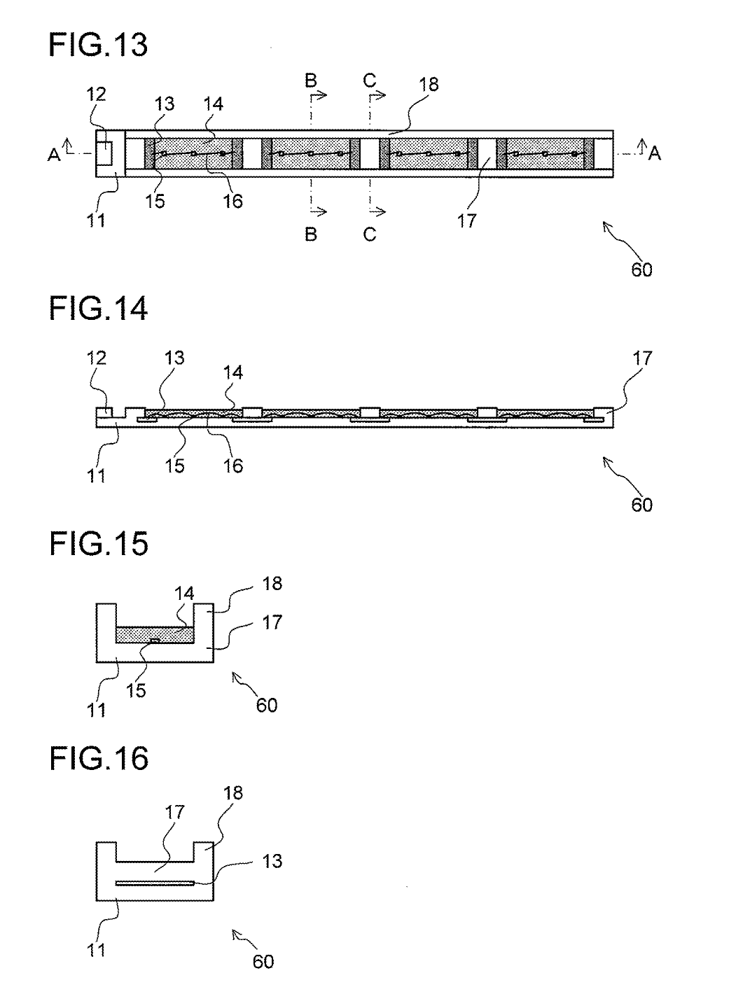

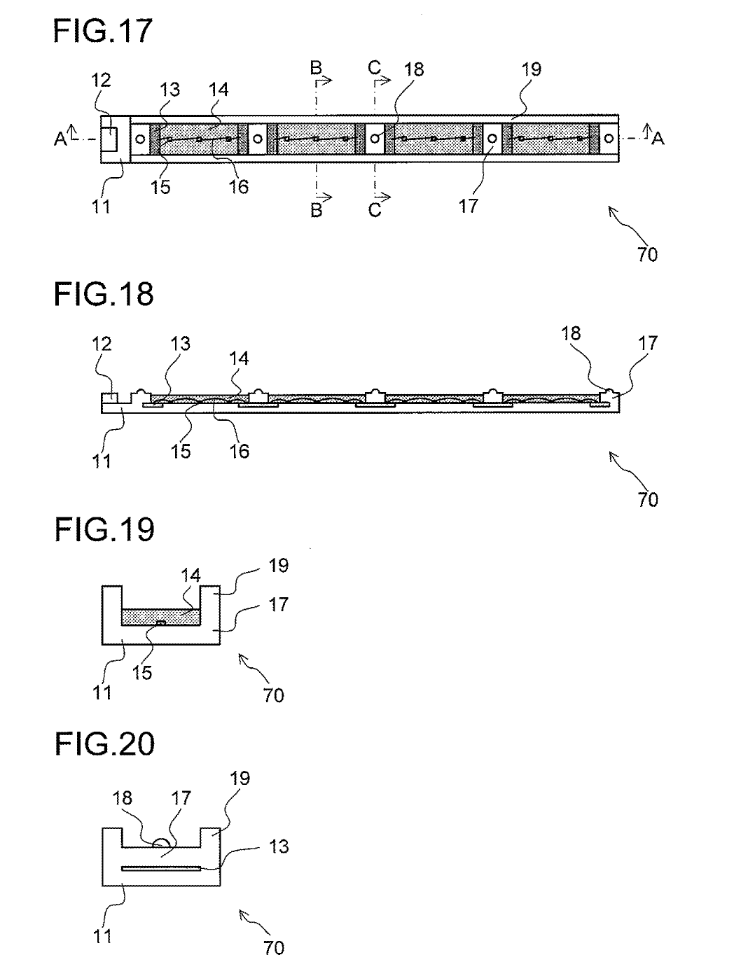

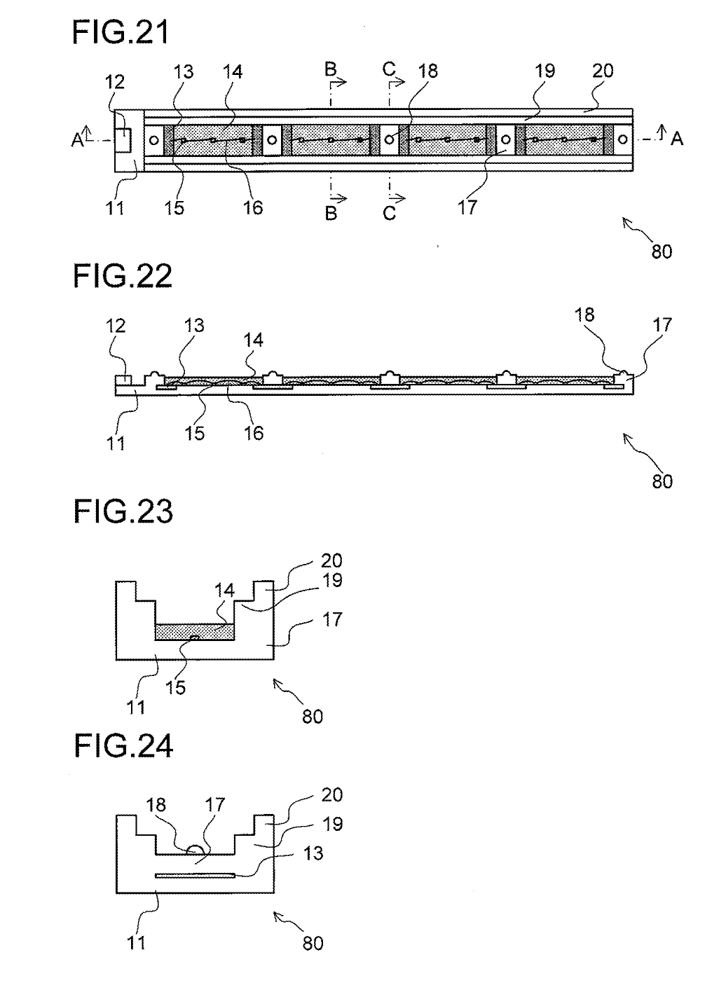

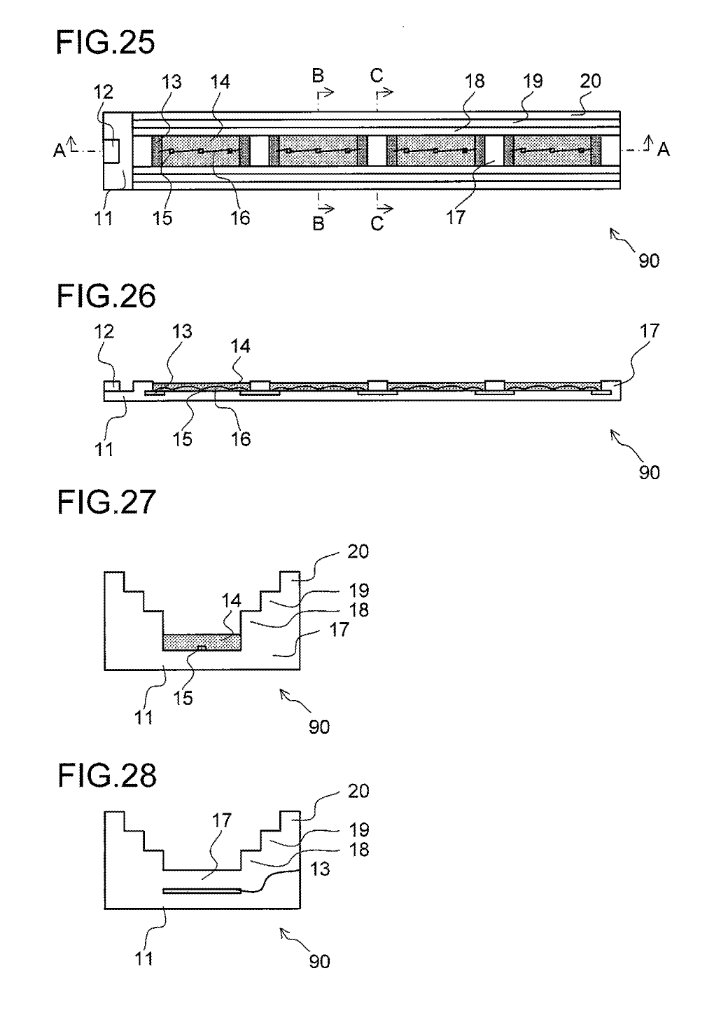

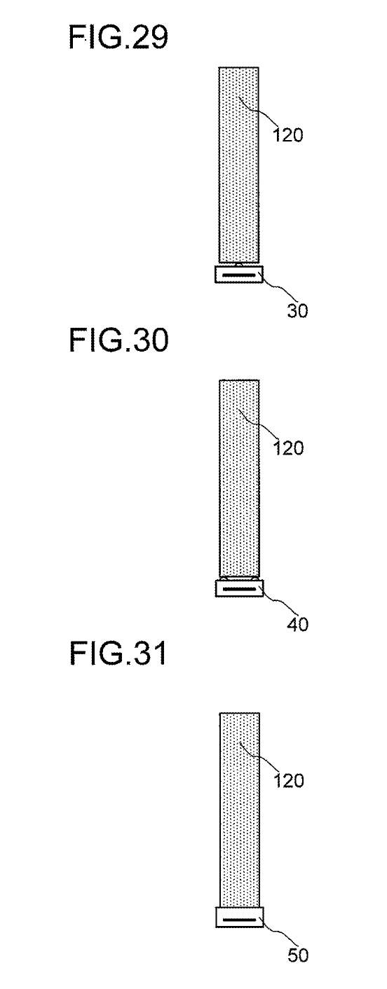

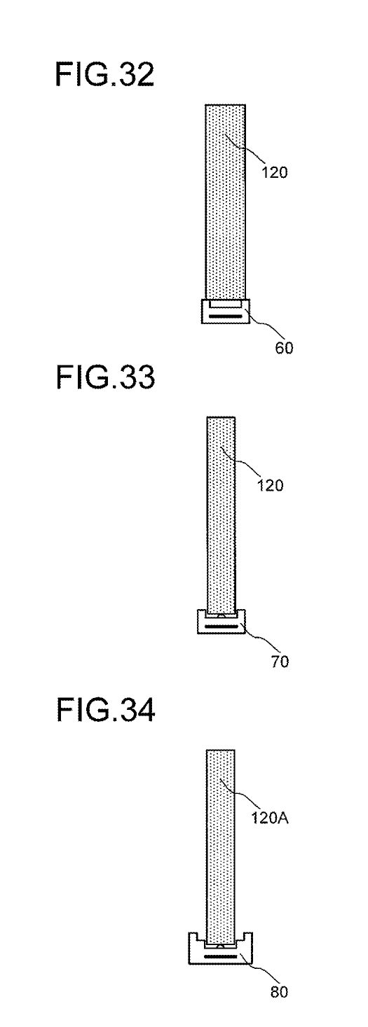

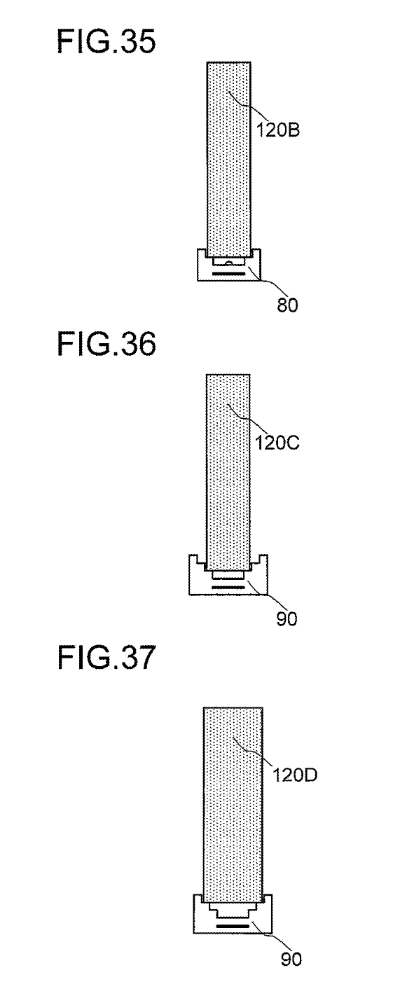

### BRIEF DESCRIPTION OF DRAWINGS

[FIG. 1] A schematic diagram illustrating the configuration of a light source substrate according to the present invention, and a sectional view along arrow A-A in FIG. 2.

[FIG. 2] A plan view of a light source substrate of a first embodiment according to the present invention.

[FIG. 3] A sectional view along arrow B-B of the light source substrate in FIG. 2.

[FIG. 4] A sectional view along arrow C-C of the light source substrate in FIG. 2.

[FIG. 5] A plan view of a light source substrate of a second embodiment according to the present invention.

[FIG. 6] A sectional view along arrow A-A of the light source substrate in FIG. 5.

[FIG. 7] A sectional view along arrow B-B of the light source substrate in FIG. 5.

[FIG. 8] A sectional view along arrow C-C of the light source substrate in FIG. 5.

[FIG. 9] A plan view of a light source substrate of a third embodiment according to the present invention.

[FIG. 10] A sectional view along arrow A-A of the light source substrate in FIG. 9.

[FIG. 11] A sectional view along arrow B-B of the light source substrate in FIG. 9.

[FIG. 12] A sectional view along arrow C-C of the light source substrate in FIG. 9.

[FIG. 13] A plan view of a light source substrate of a fourth embodiment according to the present invention.

[FIG. 14] A sectional view along arrow A-A of the light source substrate in FIG. 13.

[FIG. 15] A sectional view along arrow B-B of the light source substrate in FIG. 13.

[FIG. 16] A sectional view along arrow C-C of the light source substrate in FIG. 13.

[FIG. 17] A plan view of a light source substrate of a fifth embodiment according to the present invention.

[FIG. 18] A sectional view along arrow A-A of the light source substrate in FIG. 17.

[FIG. 19] A sectional view along arrow B-B of the light source substrate in FIG. 17.

[FIG. 20] A sectional view along arrow C-C of the light source substrate in FIG. 17.

[FIG. 21] A plan view of a light source substrate of a sixth embodiment according to the present invention.

[FIG. 22] A sectional view along arrow A-A of the light source substrate in FIG. 21.

[FIG. 23] A sectional view along arrow B-B of the light source substrate in FIG. 21.

[FIG. 24] A sectional view along arrow C-C of the light source substrate in FIG. 21.

[FIG. 25] A plan view of a light source substrate of a seventh embodiment according to the present invention.

[FIG. 26] A sectional view along arrow A-A of the light source substrate in FIG. 25.

[FIG. 27] A sectional view along arrow B-B of the light source substrate in FIG. 25.

[FIG. 28] A sectional view along arrow C-C of the light source substrate in FIG. 25.

[FIG. 29] A representative diagram illustrating the positional relationship between the light source substrate and the lightguide plate according to the present invention.

[FIG. 30] A representative diagram illustrating the positional relationship between the light source substrate and the lightguide plate according to the present invention.

[FIG. 31] A representative diagram illustrating the positional relationship between the light source substrate and the lightguide plate according to the present invention.

[FIG. 32] A representative diagram illustrating the positional relationship between the light source substrate and the lightguide plate according to the present invention.

[FIG. 33] A representative diagram illustrating the positional relationship between the light source substrate and the lightguide plate according to the present invention.

[FIG. 34] A representative diagram illustrating the positional relationship between the light source substrate and the lightguide plate according to the present invention.

[FIG. 35] A representative diagram illustrating the positional relationship between the light source substrate and the lightguide plate according to the present invention.

[FIG. 36] A representative diagram illustrating the positional relationship between the light source substrate and the lightguide plate according to the present invention.

[FIG. 37] A representative diagram illustrating the positional relationship between the light source substrate and the lightguide plate according to the present invention.

[FIG. 38] A representative diagram illustrating the positional relationship between a light source substrate and a lightguide plate according to the prior art.

[FIG. 39] A representative diagram illustrating the positional relationship between a light source substrate and a lightguide plate according to the prior art.

[FIG. 40] A plan view of a light source substrate according to the prior art.

[FIG. 41] A sectional view along arrow A-A of the light source substrate in FIG. 40.

[FIG. 42] A sectional view along arrow B-B of the light source substrate in FIG. 40.

[FIG. 43] is a sectional view along arrow C-C of the light source substrate in FIG. 40.

### DESCRIPTION OF EMBODIMENTS

Embodiments of the present invention are described below with reference to the accompanying drawings. The same reference signs are used for the same constituent members, and detailed descriptions are omitted as appropriate.

### First Embodiment

A LED light source substrate 30 of a first embodiment, which is one example of the light source substrate according to the present invention, is first described using FIGS. 1 to 4.

Here, FIG. 2 is a plan view of the LED light source substrate 30. FIG. 1 is a sectional view of the LED light source substrate 30 along arrow A-A illustrated in FIG. 2. FIG. 3 is a sectional view of the LED light source substrate 30 along arrow B-B illustrated in FIG. 2, and FIG. 4 is a sectional view of the LED light source substrate 30 along arrow C-C illustrated in FIG. 2.

The LED light source substrate 30 is a light source substrate in which a plurality of LED elements 15, being light sources, is mounted with COB on a substrate including a base member 11 and a wiring layer 13. Because wiring of a connector 12 mounted on the substrate is electrically connected to the LED elements 15 via the wiring layer 13 and bonding wires 16 (connecting member), light emission of the LED elements 15 can be controlled by a harness that is insertion-coupled with the connector 12. A sealing material 14 seals to protect the LED elements 15, bonding wires 16, and parts connected by the bonding wires. A dam 17 is provided in a shape surrounding the sealing material 14 for formation of the sealing material 14.

The dam 17 is integrally formed on the base member 11. That is, the sealing material 14 is a sealing member for sealing the plurality of light-emitting elements (LED elements 15) with the connecting member, and the configuration is such that the sealing member are held in by the dam 17. That is, a protrusion that forms the dam 17 is the first protrusion of the present invention.

In the present embodiment, the LED light source substrate 30 is configured with a protrusion 18 (second protrusion) that is higher than the dam 17.

The second protrusion (protrusion 18) has a function of preventing the sealing material 14 (sealing member) held in by the dam 17 from coming into contact with the other members. That is, even when the lightguide plate provided on the light source module and the LED light source substrate 30 are placed in contact, contacting of the lightguide plate with the sealing member (sealing material 14) can be avoided by the second protrusion (protrusion 18). Because this contact is a cause of damage to the light source substrate (LED light source substrate 30) upon damage to the light-emitting elements (LED elements 15) or connecting member, reliability and safety of the light source substrate can be increased by avoiding such contact.

FIGS. 1 and 3 depict the surface of the sealing material 14 as being lower than the dam 17. However, the height of the dam 17 on at least a short side is desirably formed low in order to avoid an optical influence of the dam 17. Therefore, the heights of the surface of the sealing material 14 and the dam may be provided without much difference, and there is also a possibility that a portion higher than the dam 17 may be produced depending on the surface state (undulation) of the sealing material 14. Accordingly, the dam 17 insufficiently functions to prevent the lightguide plate, or the like, from coming into contact with the sealing material 14.

FIG. 29 illustrates a sectional view of the placement of LED light source substrate 30 and the lightguide plate 120 when being incorporated in the light source module. The state of contact becomes as illustrated in FIG. 29 when the LED light source substrate 30 and the lightguide plate 120 are placed in contact, or when a state of contact arises due to impact, or the like. That is, a state of contact between the LED light source substrate 30 and the lightguide plate 120 arises, and the sealing material 14 is protected by the protrusion 18.

In the above description, the protrusion 18 has, for example, a hemispheric shape, but the same effect can be obtained even with another shape. Because a shape like a part of a sphere or a pyramid can focus contact with the lightguide plate 120 onto one point, the portion in contact with the lightguide plate 120 can be minimized even assuming that the portion was placed in contact with the lightguide plate 120, and the influence on optical characteristics can be kept to a minimum.

The protrusion 18, dam 17, and base member 11 can be integrally molded, for example, by injection molding, or the like. By using white resin in the raw material, a LED light source substrate 30 that incurs little optical loss and tends not to exhibit irregularity of color of incident light to the lightguide plate 120 can be made.

As described above, the first protrusion (dam 17) and the second protrusion (protrusion 18) preferably are integrally molded. By this configuration, there is no need to add a separate process for forming the second protrusion, and therefore the manufacturing cost can be reduced.

The second protrusion (protrusion 18) preferably is provided on the surface of the first protrusion (dam 17). By this configuration, the addition of shape necessary for provision of the second protrusion can be kept to a minimum, and manufacturing becomes easier.

The second protrusion (protrusion 18) preferably is a shape of a part of a sphere or is a pyramid. By this configuration, the area of the portion proximal to the lightguide plate of the light source module can be minimized, and therefore the influence of the second protrusion on optical characteristics of the light source module can be reduced.

### Second Embodiment

A LED light source substrate 40 of a second embodiment, being one example of the light source substrate according to the present invention, is next described using FIGS. 5 to 8.

Here, FIG. 5 is a plan view of the LED light source substrate 40. FIG. 6 is a sectional view of the LED light source substrate 40 along arrow A-A illustrated in FIG. 5. FIG. 7 is a sectional view of the LED light source substrate 40 along arrow B-B illustrated in FIG. 5, and FIG. 8 is a sectional view of the LED light source substrate 40 along arrow C-C illustrated in FIG. 5.

The major part of the LED light source substrate 40 has a common configuration with the LED light source substrate 30, and therefore only the points of difference are described. FIG. 30 illustrates a sectional view of the placement of the LED light source substrate 40 and the lightguide plate 120 when being incorporated in the light source module.

This embodiment differs from the first embodiment in that the lightguide plate 120 is prevented from coming into contact with the sealing material 14 by protrusions 18 that are formed in a plurality of rows in a long-side direction. By this configuration, an effect can be obtained also for a case in which the lightguide plate 120 tilts due to impact, or the like. In the aforementioned embodiment 1, there is a possibility, although it depends on the shape of the protrusion 18, that either end of the lower part of the lightguide plate 120 may contact with the sealing material 14 when the lightguide plate 120 tilts diagonally, that is, tilts in a rotating direction in the drawing illustrated in FIG. 29. By the configuration of the present embodiment, contact due to such tilting can be prevented.

That is, a plurality of second protrusions (protrusions 18) preferably is provided along the long-side direction of the substrate main body as illustrated in the present embodiment. By this configuration, contacting of the sealing material 14 with the lightguide plate 120 can be more effectively avoided compared with the case when a single protrusion is included.

### Third Embodiment

A LED light source substrate 50 of a third embodiment, being one example of the light source substrate according to the present invention, is next described using FIGS. 9 to 12.

Here, FIG. 9 is a plan view of the LED light source substrate 50. FIG. 10 is a sectional view of the LED light source substrate 50 along arrow A-A illustrated in FIG. 9. FIG. 11 is a sectional view of the LED light source substrate 50 along arrow B-B illustrated in FIG. 9, and FIG. 12 is a sectional view of the LED light source substrate 50 along arrow C-C illustrated in FIG. 9.

The major part of the LED light source substrate 50 has a common configuration with the LED light source substrate 30, and therefore only the points of difference are described. FIG. 31 illustrates a sectional view of the placement of the LED light source substrate 50 and the lightguide plate 120 when being incorporated in the light source module.

This embodiment differs from the first or second embodiment in that the second protrusion 18 has a semi-cylindrical shape, and is laid sideways in a short-side direction on the dam 17.

The LED light source substrate 50 thus configured has the same effect as that in the second embodiment, but in addition the effect can be obtained regardless of the thickness of the lightguide plate 120. In the LED light source substrate 40 illustrated in the second embodiment, the effect cannot be obtained when the lightguide plate 120 is formed so thin that its thickness is smaller than the interval of the rows of second protrusions 18 placed in a plurality of rows. In the present embodiment, this problem can be solved, and the second protrusion 18 can be determined without considering the thickness of the lightguide plate 120.

However, because the portion of contact with the lightguide plate is not a point but a line, the optical influence becomes greater particularly when the lightguide plate 120 is placed in contact with the second protrusion 18, and uneven brightness occurs comparatively more easily.

That is, as illustrated in the present embodiment, the second protrusion preferably is a protrusion that continues along the short-side direction of the substrate main body. By this configuration, the lightguide plate 120 can be stably supported regardless of the thickness of the lightguide plate 120, and therefore contacting of the sealing material with the lightguide plate can be more effectively prevented than by the aforementioned configuration.

### Fourth Embodiment

A LED light source substrate 60 of a fourth embodiment, being one example of the light source substrate according to the present invention, is next described using FIGS. 13 to 16.

Here, FIG. 13 is a plan view of the LED light source substrate 60. FIG. 14 is a sectional view of the LED light source substrate 60 along arrow A-A illustrated in FIG. 13. FIG. 15 is a sectional view of the LED light source substrate 60 along arrow B-B illustrated in FIG. 13, and FIG. 16 is a sectional view of the LED light source substrate 60 along arrow C-C illustrated in FIG. 13.

The major part of the LED light source substrate 60 has a common configuration with the LED light source substrate 30, and therefore only the points of difference are described. FIG. 32 illustrates a sectional view of the placement of the LED light source substrate 60 and the lightguide plate 120 when being incorporated in the light source module.

The LED light source substrate 60 according to the present embodiment is provided with a dam 17, and additionally is provided with a higher second protrusion 18 on both sides in the long-side direction of the substrate (that is, two are provided along the long-side direction). That is, the present embodiment has as the second protrusion 18 a long-strip-form protrusion arranged along the long-side direction of the substrate main body. By configuring the light source module as in FIG. 32, contacting of the sealing material 14 with the lightguide plate 120 is prevented by the second protrusion 18. In addition, the second protrusion 18 serves the function of a reflective member, whereby light emitted from the LED element 15 and irradiated on the second protrusion 18 is reflected in the direction of the lightguide plate. By this behavior, the light utilization efficiency of the LED light source substrate 60 is improved.

Because the second protrusion 18 includes a long-strip-form protrusion arranged along the long-side direction of the substrate main body, the lightguide plate 120 can be stably supported via the long-strip-form protrusion, and contacting of the sealing material 14 with the lightguide plate 120 can be more effectively prevented.

Also in a configuration in which the long-strip-form protrusion is provided on one side along the long-side direction of the substrate main body and the protrusion 18 described in the second embodiment is provided on the other side, this can be considered as a configuration in which a plurality of second protrusions 18 is provided along the long-side direction of the substrate main body. It is clear that the same effect as the abovementioned can be exhibited by such configuration.

### Fifth Embodiment

A LED light source substrate 70 of a fifth embodiment, being one example of the light source substrate according to the present invention, is next described using FIGS. 17 to 20.

Here, FIG. 17 is a plan view of the LED light source substrate 70. FIG. 18 is a sectional view of the LED light source substrate 70 along arrow A-A illustrated in FIG. 17. FIG. 19 is a sectional view of the LED light source substrate 70 along arrow B-B illustrated in FIG. 17, and FIG. 20 is a sectional view of the LED light source substrate 70 along arrow C-C illustrated in FIG. 17.

The major part of the LED light source substrate 70 has a common configuration with the LED light source substrate 30 or the LED light source substrate 60, and therefore only the points of difference are described. FIG. 33 illustrates a sectional view of the placement of the LED light source substrate 70 and the lightguide plate 120 when being incorporated in the light source module.

The LED light source substrate 70 is provided both with the protrusion 18 (second protrusion) of the LED light source substrate 30 and the protrusion 18 (third protrusion) of the LED light source substrate 60. These two kinds of protrusions are, in the present embodiment, described as a second protrusion 18 and a third protrusion 19 respectively. The third protrusion 19 is higher than the second protrusion 18.

By such configuration, in the state being incorporated in the light source module, contacting of the sealing part 14 with the lightguide plate 120 can be prevented by the second protrusion 18, the third protrusion 19 fixes the lightguide plate 120 in the short-side direction of the LED light source substrate 70, and the light utilization efficiency of the LED light source substrate 70 can be improved by the third protrusion 19. With the configuration illustrated with the LED light source substrate 60, there is a risk that the sealing part 14 may contact with the lightguide plate 120 when the lightguide plate 120 shifts in the short-side direction of the LED light source substrate 70, but in the present embodiment, this risk can be reduced by the fact that the lightguide plate 120 is prevented from shifting in the short-side direction of the LED light source substrate 70 by the third protrusion 19.

The second protrusion 18 described above is higher than the dam 17 and lower than the third protrusion 19. That is, in the present embodiment, by providing a projecting part (second protrusion 18) that is higher than a low portion (dam 17) and lower than a high portion (third protrusion 19), leakage of light can be prevented by the high portion, and contacting of the sealing material with the lightguide plate can be prevented by the projecting part (second protrusion 18).

### Sixth Embodiment

A LED light source substrate 80 of a sixth embodiment, being one example of the light source substrate according to the present invention, is next described using FIGS. 21 to 24.

Here, FIG. 21 is a plan view of the LED light source substrate 80. FIG. 22 is a sectional view of the LED light source substrate 80 along arrow A-A illustrated in FIG. 21. FIG. 23 is a sectional view of the LED light source substrate 80 along arrow B-B illustrated in FIG. 21, and FIG. 24 is a sectional view of the LED light source substrate 80 along arrow C-C illustrated in FIG. 21.

The major part of the LED light source substrate 80 has a common configuration with the LED light source substrate 70, and therefore only the points of difference are described. FIGS. 34 and 35 illustrate a sectional view of the placement of the LED light source substrate 80 and the lightguide plate 120 (120A, 120B) when being incorporated in the light source module.

The LED light source substrate 80 is provided with the third protrusion 19 of the LED light source substrate 70, and additionally is provided with a higher fourth protrusion 20. The fourth protrusion 20, like the third protrusion 19, is provided in the long-side-direction of the substrate, and is placed further outside from the third protrusion 19. That is, the third protrusion 19 and the fourth protrusion 20 both include long-strip-form protrusions that are arranged along the long-side direction of the substrate main body.

By the above configuration, the same effect can be obtained with respect to lightguide plates 120 (120A, 120B) having different thicknesses as in FIGS. 34 and 35 when incorporating into the light source module. When a comparatively thin lightguide plate 120A is used as in FIG. 34, the protrusion 18 can prevent contacting of the sealing material 14 with the lightguide plate 120A, the third protrusion 19 can fix the lightguide plate 120A in the short-side direction of the LED light source substrate 80, and the light utilization efficiency of the LED light source substrate can be improved by the third protrusion 19 and the fourth protrusion 20.

When a comparatively thick lightguide plate 120B is used as in FIG. 35, the third protrusion 19 can prevent contacting of the sealing material 14 with the lightguide plate 120B, the fourth protrusion 20 can fix the lightguide plate in the short-side direction of the LED light source substrate 80, and the light utilization efficiency of the LED light source substrate can be improved by the fourth protrusion 20. Although the thickness of the lightguide plate differs according to the specification of the light source module, the configuration of the LED light source substrate 80 can be used for lightguide plates 120 (120A, 120B) having a plurality of thicknesses, and the effect of the present invention can be obtained.

As described above, by adopting a configuration such that the light source substrate is provided with a third protrusion 19 and additionally is provided with a higher fourth protrusion 20, contact with the lightguide plate can be avoided by the second protrusion (protrusion 18), and the lightguide plate can be sandwiched and fixed in position by either the third protrusion 19 or the fourth protrusion 20. Leakage of light from between the light source substrate and the lightguide plate on the long side furthermore can be prevented, and light utilization efficiency can be improved. Lightguide plates having different thicknesses also can be accommodated by separating use of the third protrusion and the fourth protrusion.

### Seventh Embodiment

A LED light source substrate 90 of a seventh embodiment, being one example of the light source substrate according to the present invention, is next described using FIGS. 25 to 28.

Here, FIG. 25 is a plan view of the LED light source substrate 90. FIG. 26 is a sectional view of the LED light source substrate 90 along arrow A-A illustrated in FIG. 25. FIG. 27 is a sectional view of the LED light source substrate 90 along arrow B-B illustrated in FIG. 25, and FIG. 28 is a sectional view of the LED light source substrate 90 along arrow C-C illustrated in FIG. 25.

The major part of the LED light source substrate 90 has a common configuration with the LED light source substrate 60 or the LED light source substrate 80, and therefore only the points of difference are described. FIGS. 36 and 37 illustrate a sectional view of the placement of the LED light source substrate 90 and the lightguide plate 120 (120C, 120D) when being incorporated in the light source module.

The LED light source substrate 90 is provided with the second protrusion 18 of the LED light source substrate 60, and additionally is provided with a higher third protrusion 19 and a fourth protrusion 20 higher than the third protrusion 19. The second, third, and fourth protrusions all are provided in the long-side direction of the substrate, and the second protrusion 18, third protrusion 19, and fourth protrusion 20 are placed in order going from the inside to the outside. That is, the second, third, and fourth protrusions all include long-strip-form protrusions that are arranged along the long-side direction of the substrate main body. The protrusions also include step-form long-strip-form protrusions that become higher in stages going from the inside to the outside.

By the above configuration, the same effect can be obtained with respect to lightguide plates 120 (120C, 120D) having different thicknesses as in FIGS. 36 and 37 when incorporating into the light source module. That is, when a comparatively thin lightguide plate 120C is used as in FIG. 36, the protrusion 18 can prevent contacting of the sealing material 14 with the lightguide plate 120C, the third protrusion 19 can fix the lightguide plate 120C in the short-side direction of the LED light source substrate 90, and the light utilization efficiency of the LED light source substrate 90 can be improved by the third protrusion 19.

When a comparatively thick lightguide plate 120D is used as in FIG. 37, the third protrusion 19 can prevent contacting of the sealing material 14 with the lightguide plate 120D, the fourth protrusion 20 can fix the lightguide plate 120D in the short-side direction of the LED light source substrate 90, and the light utilization efficiency of the LED light source substrate 90 can be improved by the fourth protrusion 20.

In this case, the protrusion 18 (second protrusion) and the third protrusion 19 preferably have a flat part on an upper surface thereof. By this configuration, the other members can be stably mounted on the flat part; for example, the lightguide plate 120 (120C, 120D) can be supported over a wide area.

Although the thickness of the lightguide plate 120 (120C, 120D) differs according to the specification of the light source module, the configuration of the LED light source substrate 90 can be used for lightguide plates having a plurality of thicknesses, and the effect of the present invention can be obtained. When the second, third, and fourth protrusions thus are configured as step-form, long-strip-form protrusions along the long-side direction of the substrate main body, lightguide plates having different thicknesses can be accommodated by separating use of the plurality of protrusions. Then, in the present embodiment, thickness of even more kinds of lightguide plates can be easily accommodated by further adding protrusions including a fifth, sixth protrusion, . . . , and the like, on the outside.

As described above, by configuring with a fourth protrusion higher than the third protrusion, contact with the lightguide plate can be avoided by the second protrusion, while the lightguide plate can be sandwiched and fixed in position by either the third protrusion or the fourth protrusion. Leakage of light from between the light source substrate and the lightguide plate on the long side furthermore can be prevented, and light utilization efficiency can be improved. Lightguide plates having different thicknesses also can be accommodated by separating use of the third protrusion and the fourth protrusion.

The third protrusion 19 and the fourth protrusion 20 preferably are integrally molded with the base member. By this configuration, there is no need to add a separate process for forming these protrusions, and therefore the manufacturing cost can be reduced.

The third protrusion preferably is provided on a surface of the second protrusion (protrusion 18), and the fourth protrusion preferably is provided on a surface of the third protrusion. By this configuration, the addition of shape necessary for provision of the third and fourth protrusions 19 and 20 can be kept to a minimum, and manufacturing becomes easier.

### Other Embodiments

The effect of the present invention can be obtained even in a state in which the light source substrate (LED light source substrates 30 to 90) according to the present invention described above is not incorporated in a light source module. For example, damage to the sealing material of the LED elements, and the like, can be prevented by contacting with the lightguide plate 120 or other members during an operation of incorporation. Contact between a floor surface and the sealing material also can be prevented when performing some additional operation, for example, an operation overturning the LED light source substrate in order to affix double-sided tape on the underside in order to fix to the case 110.

In the above embodiment, a configuration in which the dam 18 was formed on a surface of the dam 17 was described, but other configurations also are possible according to the present invention. For example, the same effect can be obtained also by providing a protrusion 18 higher than the dam 17 as a protrusion independently of the dam 17 on the base member 11. Likewise there is no requirement that the protrusion 19 or the protrusion 20 be provided on a surface of the dam 17 or of another protrusion.

The dam 17 and protrusion 18, protrusion 19, and protrusion 20 were illustrated and described as being integrally formed with the base member 11, but the present invention is not limited to this, and a portion or the entirety of the dam 17 and the protrusion 18, protrusion 19, and protrusion 20 can be fabricated as separate parts and then be attached.

As described above, according to the light source substrate according to the present invention, by providing a first protrusion for forming a dam for holding in the sealing member and a second protrusion that is formed higher than the first protrusion and prevents the first protrusion from coming into contact with the other members, contact between the lightguide plate and the sealing member can be prevented and the generation of defects can be prevented in a side-edge-type LED light source module.

Furthermore by using, as a protrusion for forming the dam for holding in the sealing member, a protrusion including a first protrusion of sufficient height for holding in the sealing member, a low portion that is higher than the first protrusion and is formed in a direction following the short side of the substrate main body, and a high portion that is higher than the first protrusion and is formed in the direction following the long side of the substrate main body, the lightguide plate of the light source module can be prevented from coming into contact with the sealing member by the high portion of the protrusions. The influence of a portion of the protrusions having influence on optical characteristics also can be alleviated by making that portion lower in height. That is, characteristics of the light source substrate can be improved.

According to the present invention as described above, by providing a protrusion for avoiding contact between the sealing member and the lightguide plate of the light source module, damage to the light-emitting elements or the connecting member can be prevented, and degradation or breaking of the light source substrate can be prevented. Reliability and safety of the light source substrate therefore can be increased.

By providing a plurality of protrusions having different heights, a portion having an influence on optical characteristics can be lowered, a portion preventing leakage of light can be raised, and light utilization efficiency can be improved. Therefore, defects generated by the lightguide plate used in the light source module coming into contact with the light source substrate can be prevented, and characteristics of the light source substrate additionally can be improved.

Accordingly, with the light source module having the light source substrate and lightguide plate of the abovementioned configuration, by using a light source substrate having high reliability and safety, a light source module can be obtained, having high reliability and safety and having impact resistance such that defects including breaking of LED elements, breaking of bonding wires, and peeling of bonding wires do not occur even in the event of an impact force or other external force during mounting of the light source module. Leakage of light generated from the light source substrate also can be effectively prevented, and a light source module having improved light utilization efficiency can be obtained.

As described above, according to the light source substrate and light source module according to the present invention, defects generated by contact between the lightguide plate and the sealing material can be prevented during mounting of an edge-type light source module, and light utilization efficiency can be improved.

### INDUSTRIAL APPLICABILITY

Accordingly, the light source substrate and light source module according to the present invention can be used favorably in an edge-type light source module, in which a light source substrate COB-mounting a plurality of light-emitting elements is arranged on a side of a lightguide plate, and in which it is required to prevent a defect generated by contact between the light source substrate and the lightguide plate and to improve light utilization efficiency.

### List of Reference Signs

11 Base member

12 Connector

13 Wiring layer

14 Sealing material

15 LED element (light-emitting element)

16 Bonding wire

17 Dam (first protrusion)

18 Protrusion (second protrusion)

19 Protrusion (third protrusion)

20 Protrusion (fourth protrusion)

30 to 90 LED light source substrate (light source substrate)

100 LED light source module (light source module_

110 Case

120 Lightguide substrate

1.-24. (canceled)

25. A light source substrate used in an edge-light-type light source module, comprising:
a base member comprising a molding, a wiring layer formed on the base member, a plurality of light-emitting elements COB-mounted on the wiring layer, a connecting member for connecting the light-emitting elements and the wiring layer, and a sealing member for sealing the connecting member and the light-emitting element, wherein
the light source substrate is provided with a first protrusion that forms a dam for housing the sealing member, and a second protrusion that is formed higher than the first protrusion and prevents the sealing member from coming into contact with another member, and
the first protrusion and the second protrusion are integrally molded.

26. The light source substrate according to claim 25, wherein the second protrusion is provided on a surface of the first protrusion.

27. The light source substrate according to claim 25, wherein the second protrusion has a shape of a part of a sphere.

28. The light source substrate according to claim 25, wherein the second protrusion is a pyramid.

29. The light source substrate according to claim 25, wherein the second protrusion comprises a protrusion that continues along a short-side direction of the substrate main body.

30. The light source substrate according to claim 25, wherein the second protrusion comprises a long-strip-form protrusion that is arranged along a long-side direction of the substrate main body.

31. The light source substrate according to claim 25, wherein the second protrusion comprises a plurality of second protrusions provided along a long-side direction of the substrate main body.

32. The light source substrate according to claim 25, wherein a third protrusion that is higher than the second protrusion is integrally molded on a surface of the second protrusion.

33. The light source substrate according to claim 32, wherein the second protrusion has a flat part on an upper surface thereof.

34. The light source substrate according to claim 32, wherein a fourth protrusion that is higher than the third protrusion is integrally molded on a surface of the third protrusion.

35. The light source substrate according to claim 34, wherein the second, third, and fourth protrusions comprise step-form, long-strip-form protrusions that are arranged along a long-side direction of the substrate main body.

36. The light source substrate according to claim 34, wherein the second and third protrusions have a flat part on a surface thereof.

37. A light source substrate used in an edge-light-type light source module, comprising:
a base member comprising a molding, a wiring layer formed on the base member, a plurality of light-emitting elements COB-mounted on the wiring layer, a connecting member for connecting the light-emitting elements and the wiring layer, a sealing member for sealing the connecting member and the light-emitting element, and a protrusion forming a dam for housing the sealing member, wherein
the protrusion includes a first protrusion of sufficient height for housing the sealing member, a low portion that is formed higher than the first protrusion and is formed along a short side of the substrate main body, and a high portion that is formed higher than the first protrusion and is formed along a long side of the substrate main body.

38. The light source substrate according to claim 37, further comprising a projecting part that is higher than the low portion and is lower than the high portion.

39. The light source substrate according to claim 38, wherein the projecting part is provided on the low portion.

40. The light source substrate according to claim 25, wherein the base member comprises a white resin.

41. A light source module comprising the light source substrate according to claim 25 and a lightguide plate.

42. A light source module comprising the light source substrate according to claim 34 and a lightguide plate, wherein the lightguide plate is placed sandwiching either the third protrusion or the fourth protrusion.

43. A light source module comprising the light source substrate according to claim 37 and a lightguide plate, wherein the lightguide plate is placed sandwiching the high portion.
